(19) United States
(12) Patent Application Publication
(10) Pub. No.: US 2001/0005649 A1
(43) Pub. Date: Jun. 28, 2001

(54) Wrong insertion preventing mechanism

(76) Inventor: Shintaro Fujioka, Tokyo (JP)

Correspondence Address: Whitham, Curtis & Whitham, Reston International Center, 11800 Sunrise Valley Dr., Suite 900, Reston, VA, 20191, US

(21) Appl. No.: 09/740,856

(22) Filed: Dec. 21, 2000

(30) Foreign Application Priority Data
Dec. 22, 1999 (JP) 363685/1999

(51) Int. Cl. H01R 13/64

(52) U.S. Cl. 439/378; 439/680; 439/681

(57) ABSTRACT

A wrong insertion preventing mechanism for preventing a connector of a wrong board from being connected to a connector mounted on a mother board on a shelf is disclosed. A guide plate is installed at the opening of the shelf and has plural through holes mutually having different shapes. A guide pin which can be inserted into a specific through hole of the through holes of the guide plate is mounted on a board. The board is inserted in a right position on the shelf by the through hole and the guide pin and is never inserted onto the shelf from a wrong position. The guide pin has a projection at the end and the projection can be set to various angles.

### BACKGROUND OF THE INVENTION

1. Field of the Invention

The present invention relates to a wrong insertion preventing mechanism, particularly relates to a mechanism for preventing a wrong connector of a printed wiring board from being inserted into a connector mounted on a mother board in a cabinet.

2. Description of the Related Prior Art

Recently, various electronic equipments have configuration that plural plug-in units are housed on a shelf also called a subrack (hereinafter called a shelf). Such electronic equipment is provided with proper functions when a plug-in unit is installed in a right position on a shelf. In case a plug-in unit is not set in a right position, electronic equipment cannot acquire required functions and in addition, the plug-in unit may be broken. A plug-in unit includes a printed wiring board, a connector mounted on the board and a lever (an ejector) operated when the board is detached/attached from/to a connector of a shelf. Normally, of connected connectors, one receptacle connector is mounted on a mother board on a shelf and the other plug connector is installed in a plug-in unit. To prevent connectors from being wrongly inserted, a wrong insertion preventing component is installed in the vicinity of the connector. For example, a wrong insertion preventing component having the L-type section is installed in the vicinity of a receptacle connector and a wrong insertion preventing component having the L-type section is also installed in the vicinity of a plug connector corresponding to the component. The respective L-type wrong insertion preventing components of a receptacle connector and a plug connector to be electrically connected are installed so that its concave portion and its convex portion are fitted when the connectors approach. Also, the respective L-type wrong insertion preventing components of a receptacle connector and a plug connector to be not electrically connected are installed so that its convex portion and its concave portion mutually bump when the connectors approach. When a plug-in unit is inserted in a right position of a shelf, two L-type wrong insertion preventing components do not bump and therefore, a right plug connector is connected to a receptacle connector. When a plug-in unit is inserted in a wrong position of a shelf, the convex portions of two L-type wrong insertion preventing components mutually bump and the plug-in unit is not inserted moreover. Therefore, a receptacle connector is not connected to a wrong plug connector.

However, the conventional type wrong insertion preventing mechanism described above has the following problems. As electronic equipment is recently provided with many functions and becomes complex, the number of pins of a connector of a printed wiring board is greatly increased. Therefore, large force is required to connect connectors. Force required for insertion per pin of a certain type of connector is approximately 500 mN (millinewton) for example and in the case of a plug connector having 1000 pins, approximately 500 N is required for connecting the connector. Therefore, a conventional type plug-in unit is provided with an ejector that connects connectors. Normally, when wrong insertion preventing components installed in the vicinity of each connector bump, an operator already starts operation for connecting connectors by an ejector and it is difficult to detect resistance force caused when the wrong insertion preventing components bump. Therefore, the wrong insertion preventing components are broken or connectors are connected by mistake. For another problem, the combination of wrong insertion preventing components is limited. That is, as the combination in the number, the installed position and the orientation of the L-type wrong insertion preventing components described above is limited, the increase of the number of plug-in units installed on a shelf cannot be met. Also, a connector in which a wrong insertion preventing component cannot be set is used in large numbers.

### SUMMARY OF THE INVENTION

Therefore, the object of the invention is to provide a wrong insertion preventing mechanism which can detect wrong insertion before a connector on a shelf and a connector of a plug-in unit are touched, can sufficiently correspond to the increase of the number of plug-in units and further, can be applied to many types of connectors.

To achieve the object, the wrong insertion preventing mechanism is provided with a guide pin holder attached to a board having a connector, a guide pin held in the guide pin holder so that the guide pin can be detached and a guide plate having a through hole which is made at the opening of the shelf having the connector and which a specific guide pin can pierce.

In a concrete example of the wrong insertion preventing mechanism, the guide plate has plural through holes and each specific guide pin pierces each through hole. In another concrete example, a projection is formed at the end of the guide pin in a radial direction of the guide pin, the projection is formed in any of predetermined plural positions in the guide pin holder and plural through holes formed in the guide plate respectively have a shape corresponding to a specific position in which the projection of the guide pin is formed. The wrong insertion preventing mechanism can be provided with a lever attached to the board so that the lever can be turned, the lever can connect the connector of the board to the connector on the shelf by being turned and pressing the guide plate and can pull out the connector of the board from the connector on the shelf by being turned and pressing the guide plate. In the wrong insertion preventing mechanism, connectors to be connected can be securely connected.

### BRIEF DESCRIPTION OF THE DRAWINGS

The above and other objects, features and advantages of the present invention will become apparent from the following detailed description when taken with the accompanying drawings in which:

FIGS. 1A and 1B are perspective views respectively showing conventional type wrong insertion preventing components;

FIGS. 2A and 2B are perspective views showing conventional type receptacle connector and plug connector respectively provided with wrong insertion preventing components;

FIG. 3 is a perspective view showing a receptacle connector and a plug connector mutually touched;

FIG. 4 is a plan view showing a plug-in unit provided with a wrong insertion preventing mechanism according to the invention;

FIG. 5 is a partial enlarged view showing the plug-in unit provided with the wrong insertion preventing mechanism according to the invention;

FIG. 6 is a perspective view showing a guide pin;

FIG. 7 is an enlarged perspective view showing a guide pin holder;

FIG. 8 is a front view showing a guide plate;

FIG. 9 is an enlarged perspective view showing the wrong insertion preventing mechanism according to the invention;

FIG. 10 is a perspective view showing the insertion operation of the plug-in unit provided with the wrong insertion preventing mechanism;

FIG. 11 is a side view showing the operation of an ejector;

FIG. 12 is a perspective view showing the plug-in unit inserted into a plug connector; and

FIG. 13 is a perspective view showing the plug-in unit the insertion of which is blocked.

### DETAILED DESCRIPTION OF THE PREFERRED EMBODIMENTS

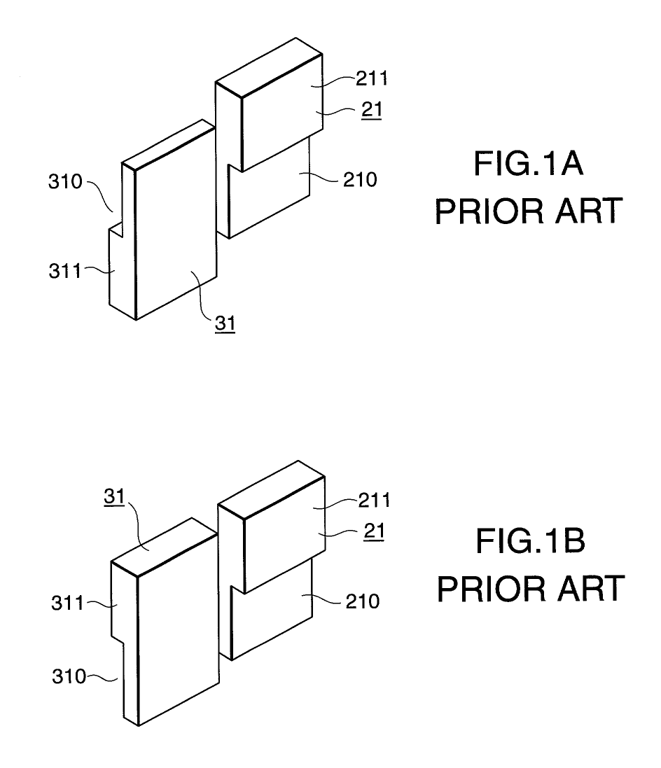

Referring to FIGS. 1A and 1B, each section in a direction in which a connector is inserted of conventional type wrong insertion preventing components 21 and 31 is L-shaped. In arrangement shown in FIG. 1A, as the convex portion and the concave portion of the components are mutually opposite, they do not bump each other and are mutually fitted. In arrangement shown in FIG. 1B, as the convex portion and the convex portion of the components and the concave portion and the concave portion of the components are opposite, they bump each other.

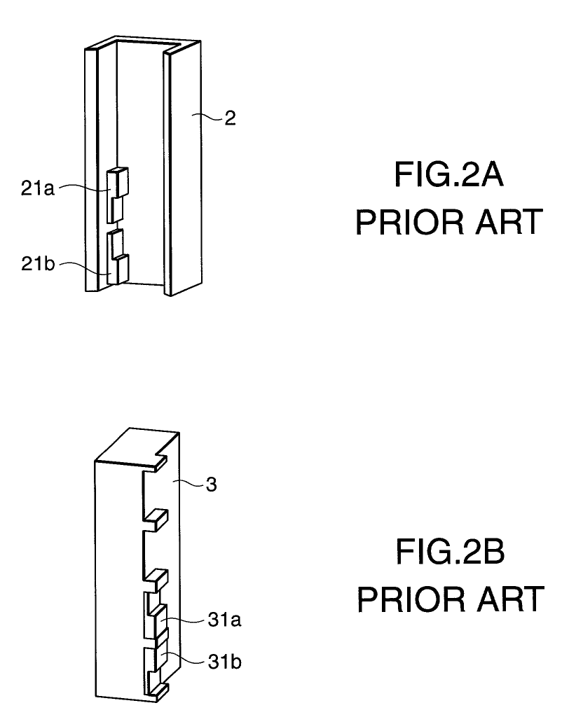

Referring to FIGS. 2A and 2B, a conventional type receptacle connector 2 is provided with L-type wrong insertion preventing components 21a and 21b and a plug connector 3 is similarly provided with L-type wrong insertion preventing components 31a and 31b. The receptacle connector 2 is mounted on a mother board on the inside of a shelf and the plug connector 3 is inserted into a plug-in unit inserted onto the shelf.

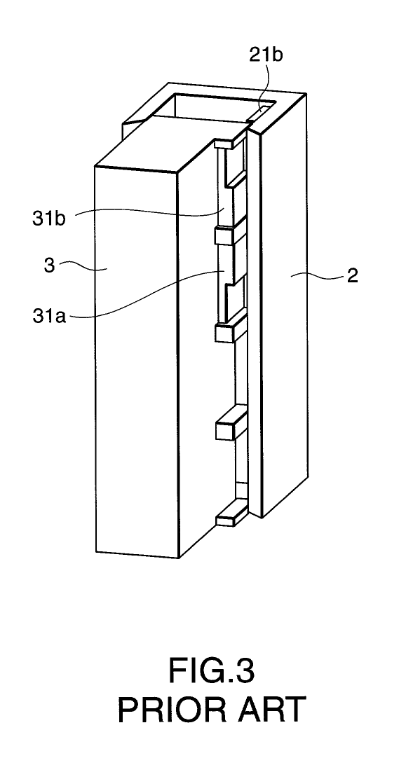

FIG. 3 shows arrangement in which the receptacle connector 2 and the plug connector 3 can be connected. At this time, the L-type wrong insertion preventing components 21a and 21b and the L-type wrong insertion preventing components 31a and 31b are mutually fitted.

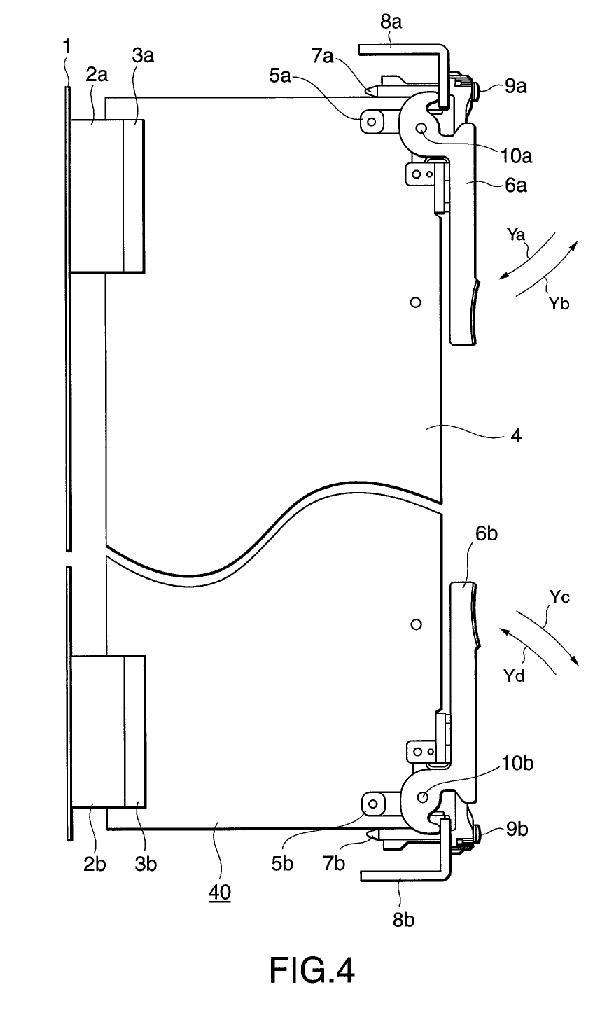

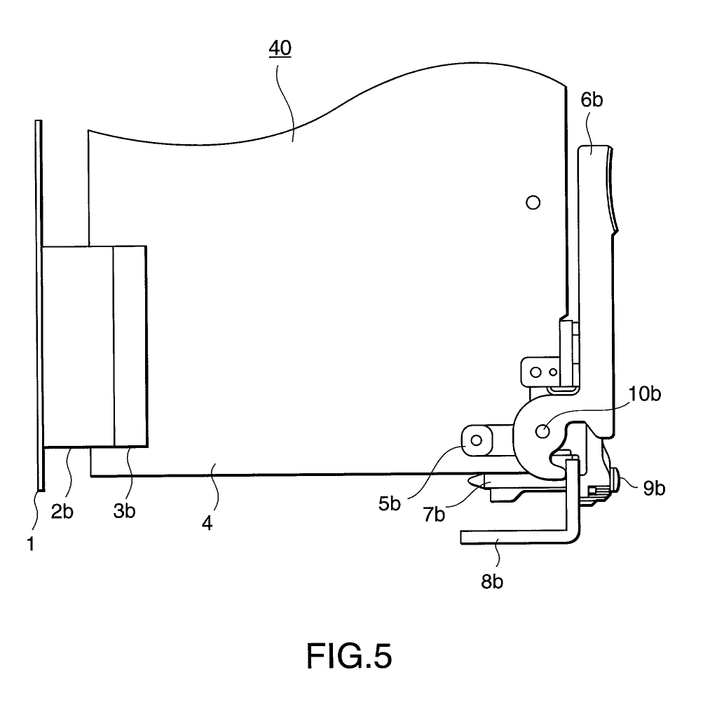

FIG. 4 shows an example of a plug-in unit 40 to which a wrong insertion preventing mechanism according to the invention is applied. FIG. 5 is a partial enlarged view of FIG. 4. The plug-in unit 40 is provided with a printed circuit board 4 and plug connectors 3a and 3b. The plug connectors 3a and 3b are respectively connected to receptacle connectors 2a and 2b mounted on a mother board 1 provided on a shelf (not shown). The printed wiring board 4 is provided with bases 5a and 5b respectively fixed with a screw at its two corners. The bases 5a and 5b are respectively provided with a guide pin holding hole for respectively holding guide pins 7a and 7b by screws 9a and 9b. The bases 5a and 5b are respectively provided with ejectors 6a and 6b and these ejectors are respectively supported by pins 10a and 10b so that the ejectors can be turned in directions of Ya, Yb and Yc and Yd respectively shown in FIG. 4. In FIGS. 4 and 5, the guide pins 7a and 7b respectively pierce through holes of guide plates 8a and 8b respectively installed at the opening of the shelf. In the wrong insertion preventing mechanism according to the invention, the guide pin and the guide plate having the through hole are basic components.

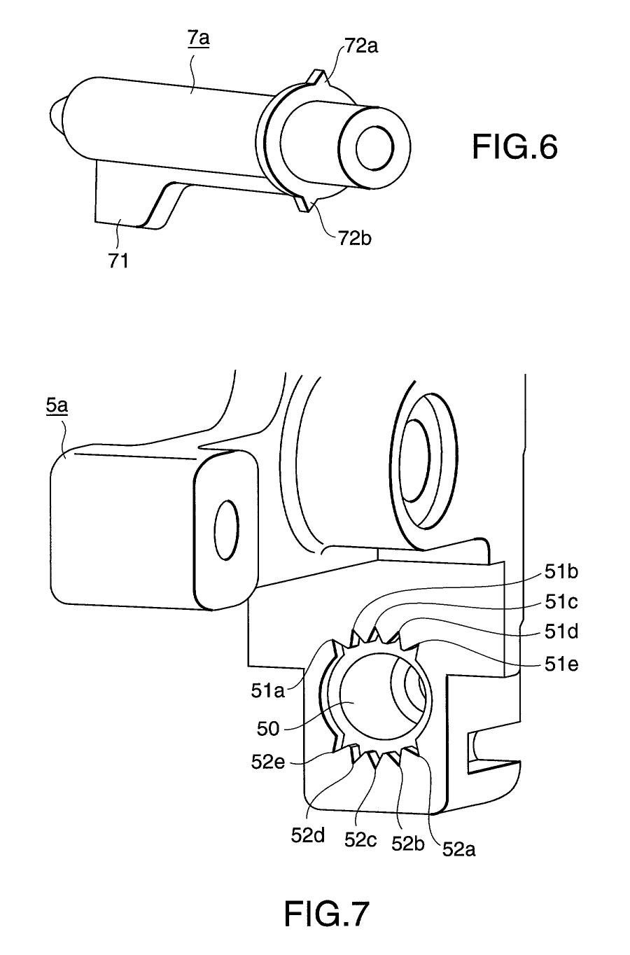

Referring to FIG. 6, the guide pin 7a in one example of the invention is provided with a plate projection 71 (hereinafter called a flag) in the vicinity of one end and two projections 72a and 72b in the vicinity of the other end.

FIG. 7 shows a guide pin holding hole 50 of the base 5a. The guide pin holding hole 50 is circular and plural slits 51a to 51e and 52a to 52e are radially formed along the periphery. The shape and the position of these slits correspond to the projections 72a and 72b of the guide pin. When the projections 72a and 72b of the guide pin are inserted into predetermined slits, the flag 71 of the guide pin is set at a specific angle. After the guide pin 7a is inserted into the guide pin holding hole 50 at a predetermined angle, it is fixed by the screw 9a.

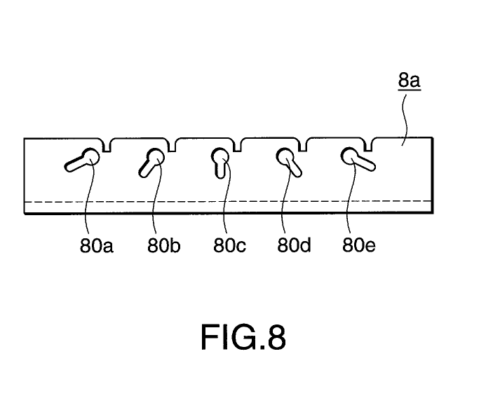

Referring to FIG. 8, the guide plate 8a is provided with five through holes 80a to 80e for example. Each through hole has a shape corresponding to the section at the end at which the flag 71 is formed of the guide pin 7a. However, each through hole 80a to 80e is different in the position of a concave portion corresponding to the flag 71. That is, each through hole 80a to 80e passes only the guide pin the flag of which is set at a specific angle. When the projections 72a and 72b of the guide pin 7a are respectively inserted into the slits 51c and 52c of the guide pin holding hole 50, the guide pin 7a can pierce only the through hole 80c of the guide plate 8a shown in FIG. 8. Similarly, when the projections 72a and 72b of the guide pin 7a are respectively inserted into the slits 51a and 52a of the guide pin holding hole 50, the guide pin 7a can pierce only the through hole 80a. For the other through holes, the guide pin having the flag set at a specific angle can be also inserted into only the specific through hole. Therefore, relationship between the guide pin having the flag and the through hole of the guide plate is similar to that between a key and a keyseat. For example, in case the specific printed wiring board 4 is connected to the receptacle connector 2a installed in a position corresponding to the through hole 80c of the guide plate, the plug connector 3a which can be inserted into the receptacle connector 2a is installed on the printed wiring board 4 and the guide pin 7a is set in the guide pin holding hole 50 so that the position of the flag 71 pierces the through hole 80c of the guide plate. The guide pin of the plug-in unit set as described above cannot pierce the other through holes of the guide plate and wrong insertion is prevented. In the example shown in FIG. 4, the guide plate is respectively installed in upper and lower parts (on paper space of FIG. 4) of the opening of the shelf. The plug-in unit 40 is provided with bases 5a and 5b and the guide pins 7a and 7b at the two corners corresponding to these guide plates. In case the types in the shape of the through holes of the guide plate are limited, the shelf provided with the two guide plates can house more plug-in units than the shelf provided with one guide plate. This reason is that many types of combinations of the guide plate through holes can be formed. The shape of the through holes of the guide plate can be changed by changing the sectional shape of the flag for example. The angles of the flag may be set to more than five types.

Next, operation for inserting the plug-in unit on the shelf and pulling out it from the receptacle connector on the shelf will be described.

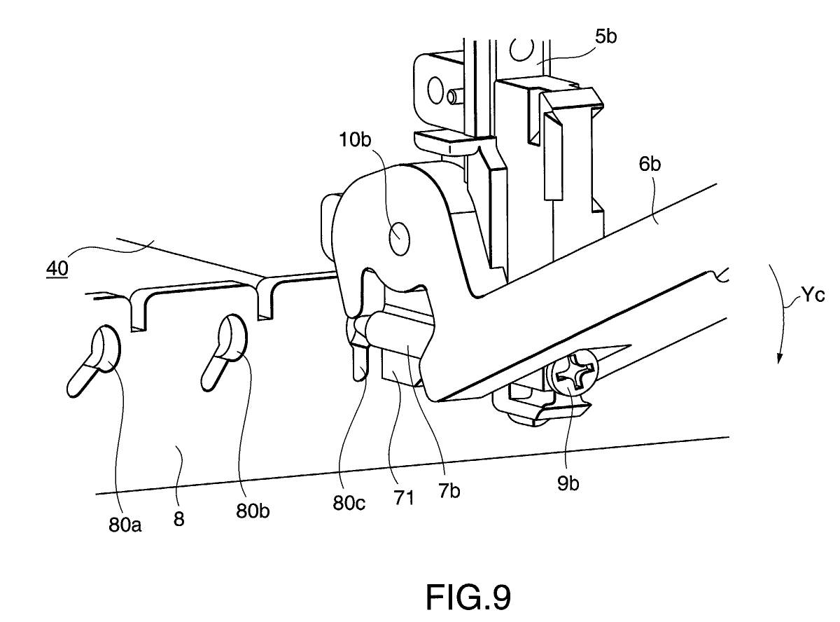

As shown in FIG. 9, the flag 71 of the guide pin 7b held on the base 5b of the plug-in unit 40 is set so that the flag corresponds to the through hole 80c of the guide plate 8. A part of the plug-in unit 40 is inserted into a slit in the vicinity of the through hole 80c and most is inserted onto the shelf (not shown). The guide pin 7b is not inserted into the through hole 80c yet. In such arrangement, when the plug-in unit 40 is further inserted, the ejector 6b supported on the base 5b by the pin 10b bump the guide plate 8 and the plug-in unit 40 is not inserted. Then, the ejector 6b is turned in a direction of Yc shown in FIG. 9.

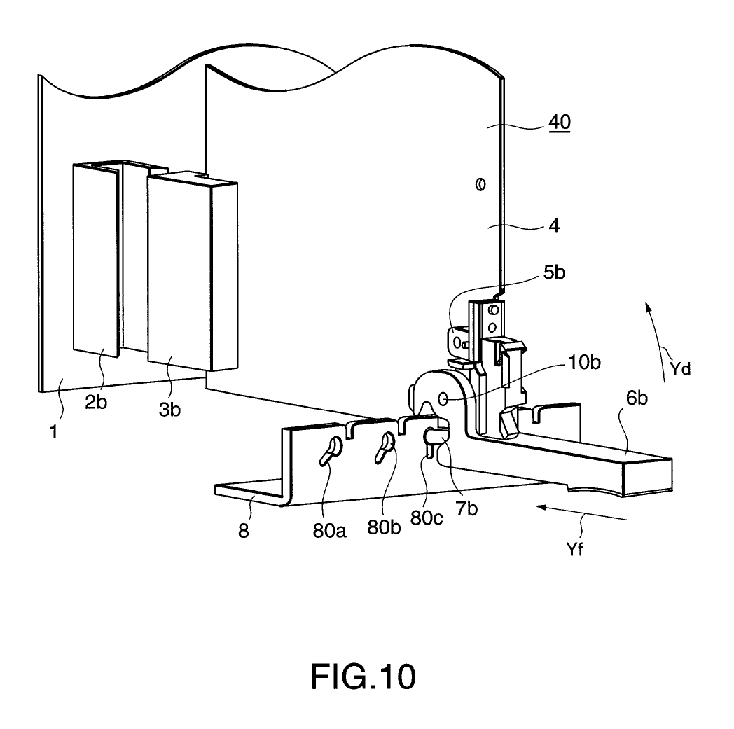

In FIG. 10, the ejector 6b is turned in the direction of Yc and is in a position in which the ejector does not bump the guide plate 8. At this time, when the plug-in unit 40 is moved in a direction of Yf shown in FIG. 10, the guide pin 7b pierces the through hole 80c of the guide plate 8 and the plug-in unit 40 is further inserted onto the shelf.

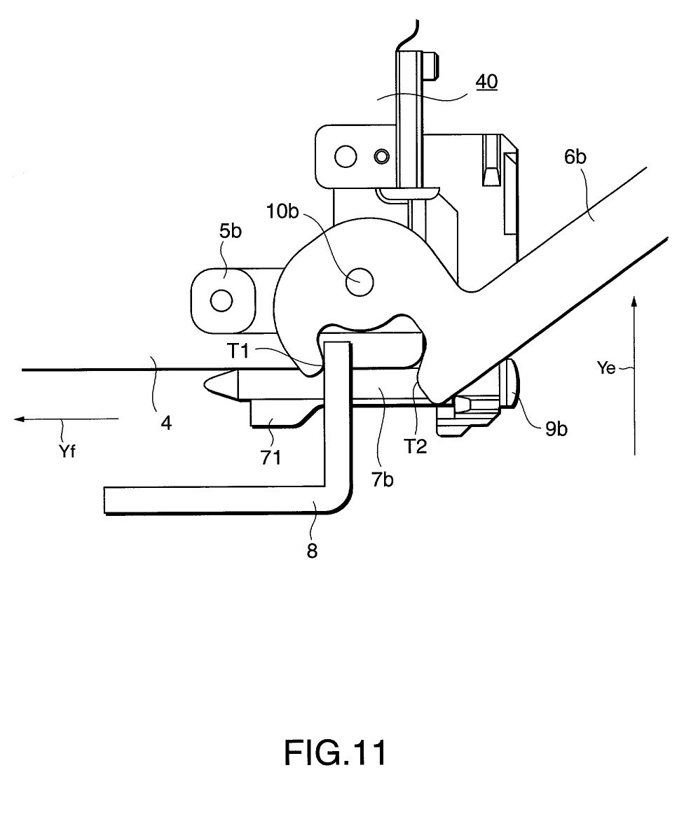

FIG. 11 shows the arrangement of the ejector 6b, the guide pin 7b, the guide plate 8 and others when the plug-in unit 40 is inserted onto the shelf, the guide pin 7b pierces the through hole and the receptacle connector 2b and the plug connector 3b approach. Afterward, the ejector 6b is operated so that these connectors are mutually connected. When the ejector 6b is pushed in a direction of Ye shown in FIG. 11, it is turned with the pin 10b in the center, the end T1 presses the guide plate 8 and the plug-in unit 40 receives force in a direction of Yf. As a result, the plug connector 3b of the plug-in unit 40 is inserted into the receptacle connector 2b and is connected to it.

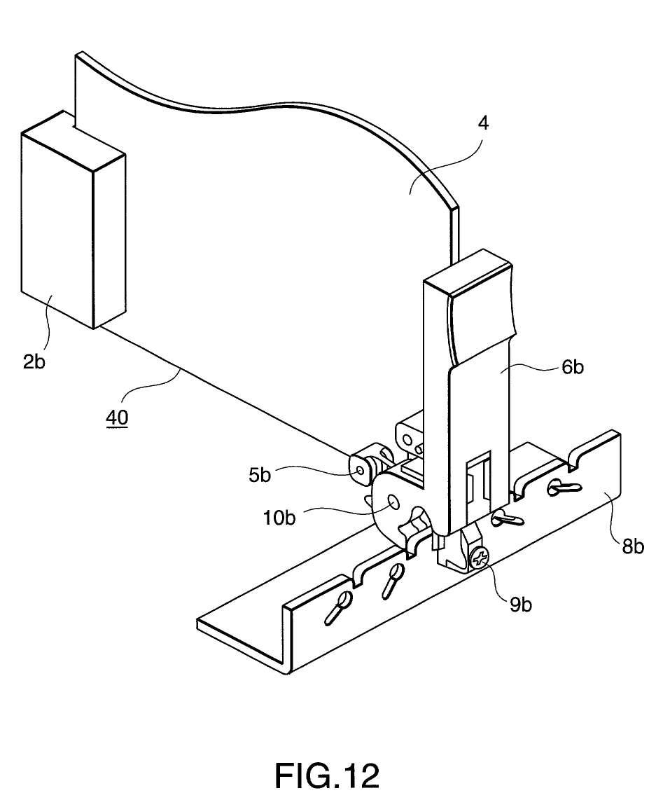

FIG. 12 shows the plug-in unit 40 connected to the receptacle connector 2b after the operation of the ejector 6b. Afterward, to release the electric connection of the connectors, the ejector 6b is turned in a direction reverse to the direction of Ye shown in FIG. 11. Then, the end T2 of the ejector 6b presses the guide plate 8 and applies stress in a direction reverse to Yf shown in FIG. 11 to the plug-in unit 40.

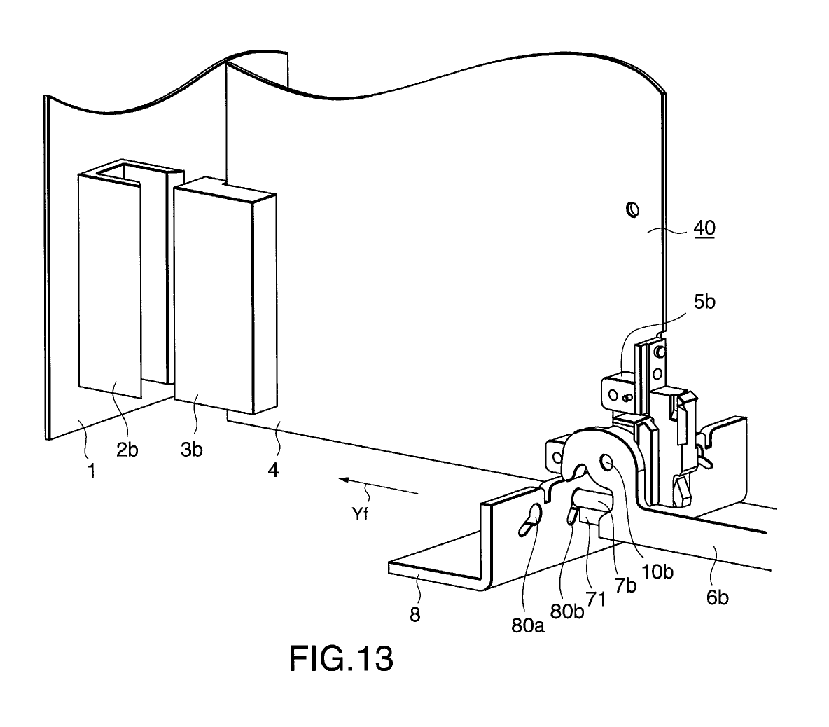

FIG. 13 shows an example that the plug-in unit 40 is inserted from a wrong position. The flag 71 of the guide pin 7b is set so that it is fitted to the through hole 8c of the guide plate, however, the plug-in unit 40 is inserted onto the shelf from a position of the through hole 8b of the guide plate 8. The shape of the through hole 8b of the guide plate 8 is not fitted in a position of the flag 71 of the guide pin 7b and the receptacle connector 2b is prevented from being connected to the wrong plug connector 3b.

As described above, the guide pin provided with the flag at the end is installed in the plug-in unit so that the guide pin corresponds to plural through holes of the guide plate one to one and prevents the plug-in unit from being inserted onto the shelf from a wrong position. The guide pin also has a function for guiding the plug-in unit after it is inserted into the through hole of the guide plate. Plural guide pins are installed at the opening of the shelf and a through hole into which a specific guide pin is inserted may be also made in each plug-in unit. In the invention, the guide pin having the same structure can be applied to many plug-in units.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A mechanism for preventing a connector from being wrongly inserted, comprising:
a guide pin holder attached to a board provided with a connector;
a guide pin held in the guide pin holder so that the guide pin can be detached; and
a guide plate installed at the opening of a shelf provided with a connector, wherein:
the guide plate has a through hole which a specific guide pin can pierce.

2. A wrong insertion preventing mechanism according to claim 1, wherein:
a guide plate has plural through holes; and
a specific guide pin pierces each through hole.

3. A wrong insertion preventing mechanism according to claim 1, wherein:
the shape of a through hole corresponds to the specific sectional shape of the vicinity of the end of a guide pin.

4. A wrong insertion preventing mechanism according to claim 1, wherein:
a guide plate has a slit into which a part of a board is inserted in the vicinity of the through hole.

5. A wrong insertion preventing mechanism according to claim 1, wherein:
a projection is formed in a radial direction of the guide pin at the end of the guide pin.

6. A wrong insertion preventing mechanism according to claim 5, wherein:
a guide pin is held in a guide pin holder so that the projection is set in any of predetermined plural positions.

7. A wrong insertion preventing mechanism according to claim 6, wherein:
the through hole of a guide plate corresponds to the sectional shape in the vicinity of the end of a guide pin the projection of which is set in a specific position.

8. A wrong insertion preventing mechanism according to claim 1, wherein:
a projection is formed in a radial direction of the guide pin at the end of the guide pin;
the guide pin is held in a guide pin holder so that the projection is set in any of predetermined plural positions; and
plural through holes formed in the guide plate respectively have a shape corresponding to a specific position in which the projection of the guide pin can be set.

9. A wrong insertion preventing mechanism according to claim 1, wherein:
a lever attached to a board so that the lever can be turned is provided; and
a connector of the board can be connected to a connector on a shelf by turning the lever and pressing a guide plate.

10. A wrong insertion preventing mechanism according to claim 9, wherein:
a connector of a board can be pulled out from a connector on a shelf by turning a lever and pressing a guide plate.

11. A wrong insertion preventing mechanism according to claim 2, wherein:
a guide pin holder is attached in the vicinity of one corner of a board; and
a guide plate is installed on the side corresponding to the guide pin holder at the opening of a shelf.

12. A wrong insertion preventing mechanism according to claim 1, wherein:
a guide pin holder is respectively attached in the vicinity of two corners of a board; and
a guide plate is installed in a position corresponding and mutually opposite to the guide pin holder at the opening of a shelf.

13. A wrong insertion preventing mechanism according to claim 12, wherein:
plural through holes respectively formed in two guide plates are different in an arrangement.

14. A wrong insertion preventing mechanism according to claim 6, wherein:
the guide pin inserting hole of a guide pin holder has plural slits; and
a guide pin has projections corresponding to the slits.
